(19) United States
(12) Patent Application Publication
(10) Pub. No.: US 2026/0035150 A1
(43) Pub. Date: Feb. 5, 2026

(54) ILLUMINATED CONTAINER TOP

(71) Applicant: Prism Innovations LLC, Houston, TX (US)

(72) Inventors: Matthew B. Steele, Houston, TX (US); Luke B. Lumpkin, Houston, TX (US); Bruce E. Larsen, Houston, TX (US); Steven A. Barron, Houston, TX (US)

(21) Appl. No.: 19/357,776

(22) Filed: Oct. 14, 2025

Related U.S. Application Data
(63) Continuation-in-part of application No. 18/326,163, filed on May 31, 2023.

(51) Int. Cl. B65D 51/24; F21V 5/02; F21W 131/30

(52) U.S. Cl. CPC B65D 51/248; F21V 5/02; F21W 2131/30

(57) ABSTRACT

An illuminated container top having a light source, a power source in electronic communication with the light source, and a geometric structure, wherein the light source illuminates the geometric structure. The geometric structure can structure can comprise a prism. The geometric structure, either uniformly or with varying portions being opaque, transparent, or translucent can be configured for specific lighting effects.

### FIELD

The present disclosure generally relates to an illuminated container top.

### BACKGROUND

The sale of retail products is a highly competitive industry. Stores often operate with small profit margins and are required to house significant levels of inventory. For example, many grocery stores have between a one percent and three percent operating profit.

Regularly, stores will carry many different brands of a specific product. Customers are attracted by a wide selection variety and many customers will maintain brand preferences and loyalties.

Certain products may be more profitable for stores and are highlighted for the customer. Sale prices, “buy one, get one” promotions, and strategic placement of products are often utilized by stores to boost sales of specific products. Manufacturers of product also utilize various eye-catching color schemes, container shapes, and gimmicks to attract the attention of a customer.

Because of the number of competitors that most products have, it is desirable to attract the attention of a customer to enhance the sales of a product.

The present disclosure provides a novel type of illuminated container top designed to attract the attention of a potential customer.

### SUMMARY OF THE INVENTION

The present disclosure relates to an illuminated container top. The illuminated container top can be used on various product containers to attract the attention of a customer, thereby leading to increased product sales.

### BRIEF DESCRIPTION OF THE DRAWINGS

The detailed description will be better understood in conjunction with the accompanying drawings as follows:

FIG. 1 depicts a perspective view of an embodiment of the present invention.

FIG. 2 depicts a cut view of the embodiment shown in FIG. 1.

FIG. 3 depicts an embodiment of the present invention on a bottle.

FIG. 4 depicts an embodiment of the present invention on a jar.

The embodiments of the present disclosure are detailed below with reference to the listed Figures.

### DETAILED DESCRIPTION OF THE EMBODIMENTS

Before explaining the present disclosure in detail, it is to be understood that the present disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to an illuminated container top. The illuminated container top can be used on various product containers to attract the attention of a customer, thereby leading to increased product sales.

The present disclosure is novel in that the top itself is illuminated, allowing for use on various types of products and containers. The top can contain a prism in order to produce a specific lighting effect.

For the present disclosure, prism can refer to any structure that can refract light and separate white light into one or more component colors. Exemplary prisms include, but are not limited to: transparent objects with refracting surfaces that separate white light into a partial or full spectrum of colors. In embodiments, a traditional transparent object with refracting surfaces at an acute angle with each other that separates white light can be used. In other embodiments, the prism can be a transparent or translucent object which accomplishes the separation of white light into component colors by being comprised of different materials of different degrees of transparency or translucency.

In general, the term prism shall refer to a transparent or translucent optical element that is designed to refract light.

Furthermore, the top is customizable by persons having ordinary skill in the art for specific applications to achieve specific lighting effects.

While exemplary embodiments will be described in relation to a top for a bottle, this is not intended to be limiting in any manner. The top of the present disclosure can be utilized for jars, boxes, bottles, or any container known to persons having ordinary skill in the art.

The illuminated container top can have a light source, a power source in electronic communication with the light source, and a geometric structure comprising a prism, wherein the light source illuminates the geometric structure. The illuminated container top can be detachable, re-attachable to the container, or reusable for other containers

The container can be any container known to persons having ordinary skill in the art. Exemplary containers include bottles, jars, pots, boxes, or any other packaging used for products. The illuminated container top can be appropriately sized shaped to fit various types of containers with various forms of attachment. The most likely embodiments shall be containers which are bottles or jars.

The light source can be any light source known to persons having ordinary skill in the art. While typically, one or more light emitting diodes (LEDs) will be used, incandescent lights, photoluminescent coatings, and the like can be utilized as desired by persons having ordinary skill in the art. LEDs are preferred due to their low power consumption, long life, availability of colors, and cost.

The power source can be a chemical battery or a photoelectric cell to provide power to the light source. In embodiments, the power source can be rechargeable. The power source can be rechargeable in either a wired or wireless manner. It is contemplated that the illuminated top can be recycled, reused, or repurposed in some manner, thereby making it desirable to recharge the power source from time to time.

A geometric structure can be positioned such that the light source illuminates the geometric structure. The geometric structure can be opaque, transparent, or translucent as desired by persons having ordinary skill in the art for a desired effect and appearance.

In embodiments, the geometric structure can be or comprise a prism. The prism, either uniformly or with varying portions being opaque, transparent, or translucent can be configured for specific lighting effects. In embodiments, the geometric structure can also be an object, a portion of an object, an animal figure, or a portion thereof (such as a head or a claw). The geometric structure can be a brand, a logo, a product representation, and the like. In embodiments, the geometric structure can be a person's likeness.

In embodiments, the geometric structure can have an engraved image, phrase, or other visual feature configured to interact in some manner with light from the light source. In embodiments, the engraving can act as a prism to refract light and create a lighting effect as desired by persons having ordinary skill in the art.

In embodiments, the illuminated top can have a cover to enclose its components partially or completely. For example, the cover could be positioned over the power source, the light source, the geometric structure, or any combination thereof. The cover can be clear or translucent. In other embodiments, however, the cover is not used in order to allow the geometric shape to be more visible and emphasized.

The illuminated top can also include a circuit board to control the light source. The circuit board can be a printed circuit board with a pre-programmed set of instructions. In embodiments, the circuit board can be programmed, and/or reprogrammed, such as with an erasable programmable read-only memory (EPROM).

In embodiments, the illuminated top can comprise threads to allow for the top to be screwed on to a bottle, a jar, and the like. Either male or female threads can be included. In other embodiments, the illuminated top can be friction fit, attached with adhesive, magnetically attached, or affixed using any technique known to persons having ordinary skill in the art.

The following is an exemplary embodiment of the present disclosure:

The illuminated top can comprise a circular printed circuit board with three LEDs positioned thereon. A small coin battery is also housed on the circuit board to power the LEDs. The circuit board has been programmed to provide power to the LEDs (i.e. turn them on) for two seconds and then withdraw power for two seconds to create a slow flashing lighting effect.

A translucent geometric structure of a bear is positioned above the LEDs and is also affixed to the circuit board. The word “kodiak” is laser etched onto the geometric structure of a bear. A transparent dome cover attaches to the printed circuit board. The cover extends below the printed circuit board and comprises thread, thereby allowing it to screw onto a bottle.

In embodiments, a prism can be included within the bear to create a multi-colored lighting effect.

Persons having ordinary skill in the art will recognize that numerous combinations of types of lights, lighting effects and programs, geometric structures, prisms, positions of the lights and/or geometric structure, and covers can be utilized as desired.

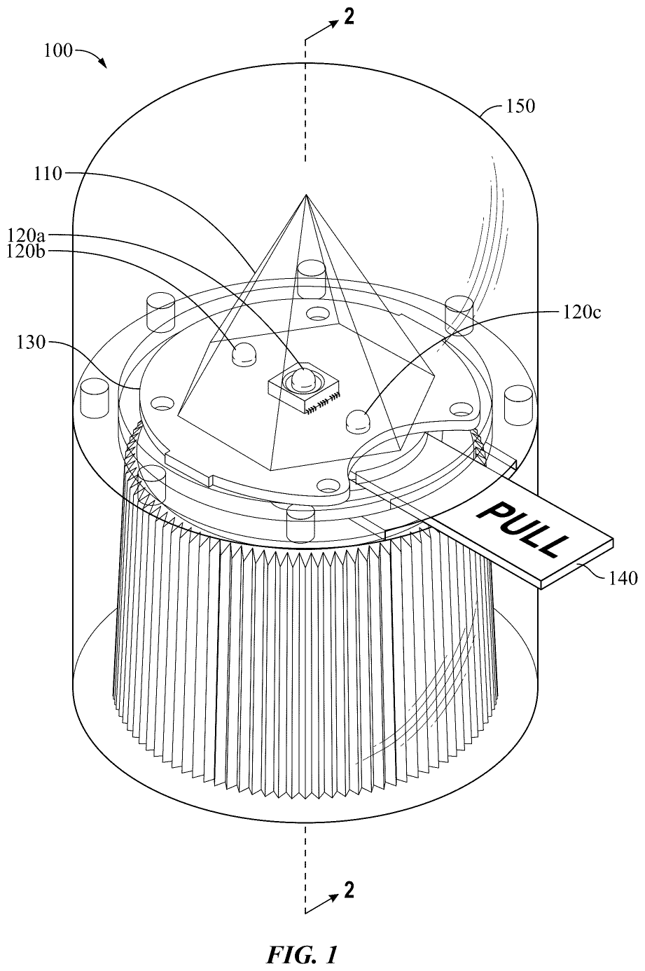

Turning now to the Figures, FIG. 1 depicts a perspective view of an embodiment of the present invention.

The illuminated top 100 can comprise a geometric structure 110, one or more light sources 120a, 120b, 120c, a circuit board 130, a pull tab 140, and a cover 150.

The geometric structure 110 can be any structure as desired. The geometric structure 110 can be a shape, an object, a portion of an object, an animal, a portion thereof (such as a head or a claw), a brand name, a logo, a product representation, lettering, and the like. In embodiments, the geometric structure can be a person's likeness.

The geometric structure 110 as shown in this embodiment is a prism. The geometric structure 110 can be transparent or translucent to allow for different amounts of light to pass through. In embodiments, the geometric structure 110 can be opaque or reflective to achieve a specific result as desired by persons having ordinary skill in the art.

The illuminated top 100 can have light sources 120a, 120b, and 120c. While typically light emitting diodes (LEDs) will be utilized for their energy efficiency, size, and cost, any light source 120 as applicable for a specific application can be utilized by persons having ordinary skill in the art. While light source 120 is shown below or within the geometric structure 110, in embodiments the light source 120 can be placed external to the geometric structure 110.

The illuminated top 100 can also have a circuit board 130 to control the light source 120. A switch 140 can be used to connect the circuit board 130 and/or the light source 120 to a power source. A cover 150 can encompass all or some of the components.

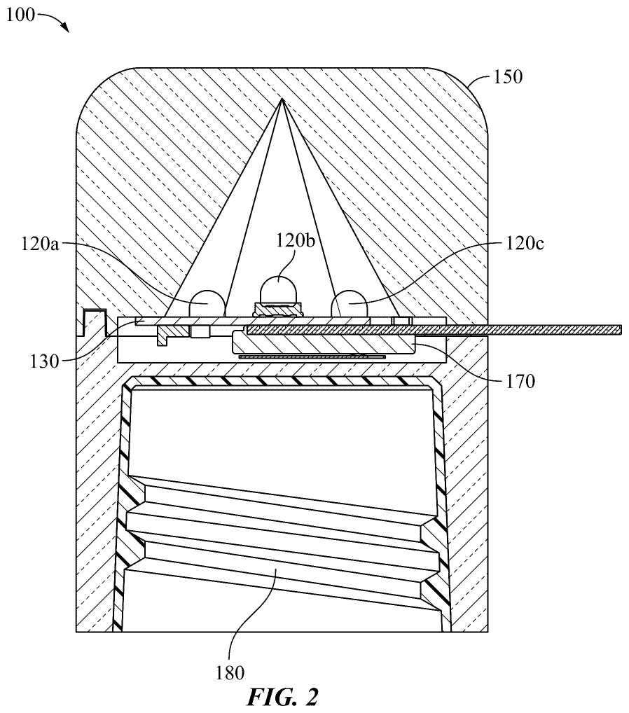

FIG. 2 depicts a cut view of the embodiment shown in FIG. 1.

Shown here is cover 150 encompassing geometric structure 110, light sources 120a, 120b, 120c circuit board 130 and battery 170. The circuit board 130 and/or light source 120 can be activated upon removal of switch 140, shown here as a pull tab.

The illuminated top 100 can be affixed to a bottle cap with threads 180, or the illuminated top 100 can have threads 180 to directly screw onto a bottle. Any other form of attachment as known to persons having ordinary skill in the art can also be utilized.

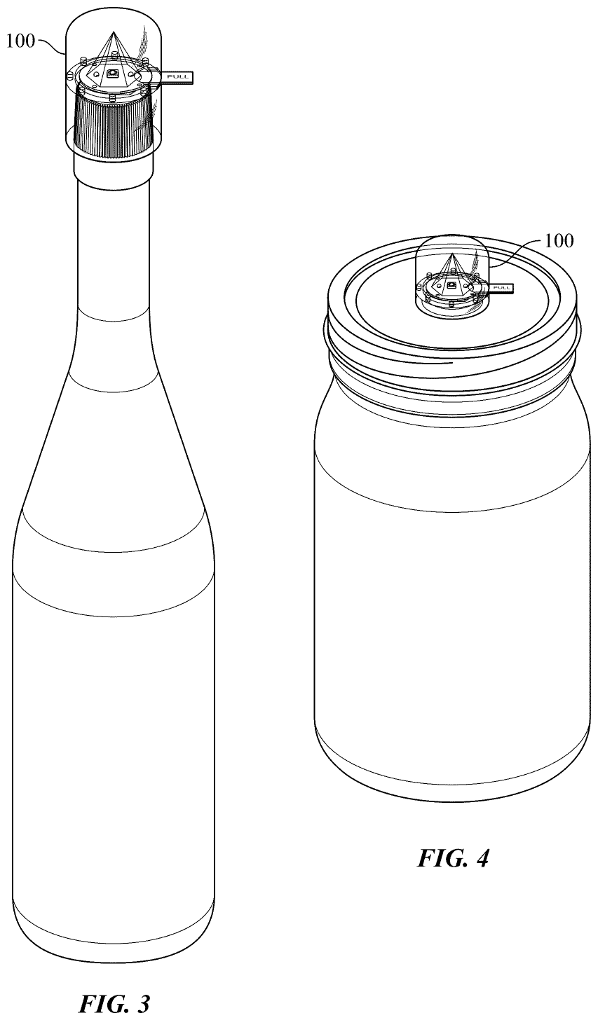

FIG. 3 depicts an embodiment of the present invention on a bottle.

In this embodiment, the illuminated top 100 has been friction fit onto a bottle cap.

FIG. 4 depicts an embodiment of the present invention on a jar.

In this embodiment, the illuminated top 100 has been attached to a jar with an adhesive and/or other fastener.

While the present disclosure emphasizes the presented embodiments and Figures, it should be understood that within the scope of the appended claims, the disclosure might be embodied other than as specifically enabled herein.

What is claimed is:

1. A top for a container comprising:
a. a light source;
b. a power source in electronic communication with the light source; and
C. a geometric structure comprising a prism, wherein the prism is configured to separate white light into a partial or complete spectrum to achieve a specific lighting effect; and
wherein the light source illuminates the geometric structure.

2. The top of claim 1, further comprising a cover for the light source, the power source, or the geometric structure.

3. The top of claim 1, further comprising a thread for connecting to the container, wherein the thread is a male thread or a female thread.

4. The top of claim 1, further comprising a circuit board for controlling the light source.

5. The top of claim 1, wherein the light source is at least one light emitting diode.

6. The top of claim 1, further comprising a switch for the light source.

7. The top of claim 1, wherein the power source is rechargeable.

8. The top of claim 1, wherein the power source is wirelessly rechargeable.

9. The top of claim 1, wherein the geometric structure is opaque

10. The top of claim 1, wherein the geometric structure is translucent.

11. The top of claim 1, wherein the geometric structure is transparent.

12. The top of claim 1, wherein the geometric structure comprises a prism.

13. The top of claim 1, wherein the geometric structure comprises an engraved image.

14. The top of claim 2, wherein the cover is transparent or translucent.

15. A top for a container comprising:
a. a circuit board having one or more light emitting diodes thereon;
b. a power source in electronic communication with the one or more light emitting diodes;
c. a geometric structure comprising a prism positioned proximate the one or more light emitting diodes; and
d. a cover encompassing at least the circuit board, wherein the cover is fastened to the printed circuit board; and
wherein light from the one or more light emitting diodes travels through the prism to create a lighting effect

16. The top of claim 15, further comprising a means of attachment to a container.

17. The top of claim 15, further comprising a switch for activating the one or more light emitting diodes.

18. The top of claim 15, wherein the cover encompasses the geometric structure.
